(19) United States
(12) Patent Application Publication
(10) Pub. No.: US 2020/0219029 A1
(43) Pub. Date: Jul. 9, 2020

(54) SYSTEM AND METHOD FOR MONITORING AND MANAGING ENTERPRISE DATA

(71) Applicant: Siva Kumar, Norwood, MA (US)

(72) Inventor: Siva Kumar, Norwood, MA (US)

(73) Assignee: Cloud Square Inc., Norwood, MA (US)

(21) Appl. No.: 16/243,723

(22) Filed: Jan. 9, 2019

(51) Int. Cl. G06Q 10/06; G06F 21/62; G06F 3/0484

(52) U.S. Cl. CPC G06Q 10/06313; G06F 3/0484; G06F 21/6218

(57) ABSTRACT

A system and method for customizing, monitoring, and managing data sets for enterprises are provided. A web user interface layer receives requests from a user and transmits the request to a processing layer which transmits a processing request via a parsed request and transmit the processing request to an event handler. The event handler determines if the processing request requires access to data in a data repository in communication with a data interface layer. The data interface layer issues an interface call to the data repository to access the data and execute the processing request. A personalization engine contained in a presentation layer permits the user to select a presentation scheme. The presentation layer receives the executed processing request from the data interface layer and determines a presentation scheme corresponding to the user. The presentation scheme displays the executed processing request data on a user interface on a computing device.

### TECHNICAL FIELD

The embodiments generally relate to system and methods for monitoring and managing data, and more specifically, to monitoring and managing the activities and data of an enterprise.

### BACKGROUND

Advances in data storage systems have greatly improved the efficiency of data recovery and analysis. With the increasing use of the internet, enterprises including corporations, governments, non-profit groups, and other organizations (collectively “enterprises”) can now operate globally in a collective effort to complete a project. Effectively monitoring and managing remote individuals is now a necessity for many large enterprises.

Often, large enterprises are divided by departments, locations, programs, teams, initiatives, and subsidiaries, each having a unique group of employees and functions. Each division within the company poses a logistical problem in regard to data management and monitoring. Current systems for managing this data lack cohesiveness and do not provide for seamless data monitoring and management. Members of an enterprise are often unable to efficiently or accurately monitor personnel and project status without consulting multiple various databases and interfaces. Monitoring project assignments, project progress, decisions, schedules, deadlines, assets, etc. requires significant laborious effort through various means.

Although systems and methods have been created which aggregate project data into a single suite, these systems lack data visualization techniques which allow visualization of a hierarchy of enterprise data in a single interface. The current systems are unable to efficiently display project planning, reporting, issue management, time and expenses, document repositories, policy management, and productivity tools in a single graphical display to various members of an enterprise to enhance productivity, transparency, and ensure adherence to policies.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

A system and method for customizing, monitoring, and managing an enterprise are provided. A web user interface layer receives a request from a user and transmits the request to a processing layer configured to transmit a processing request via a parsed request and transmit the processing request to an event handler. The event handler determines if the processing request requires access to data stored in a data repository in communication with a data interface layer. The data interface layer issues an interface call to the data repository to access the data and execute the processing request. A personalization engine contained in a presentation layer permits the user to select a presentation scheme. The presentation layer receives the executed processing request from the data interface layer and determines a presentation scheme corresponding to the user. The presentation scheme displays the executed processing request data on a user interface on a computing device.

In one aspect, the web user interface layer receives the request from the user and transmits an output signal to the presentation layer.

In one aspect, a security manager interface is controlled by an administrator or by users within the enterprise. The security manager interface is displayed on the user interface to permit the administrator to select data permissions for the user. The web user interface layer then validates the request via the security manager before the request is transmitted to the processing layer.

In one aspect, a data snippets interface permits the user to create customized data schemes displayed on the user interface.

In one aspect, the processing engine determines a request type, wherein the request type includes: requests to be executed by the event handler, requests to display data to be transmitted to the presentation layer, and a plurality of pre-determined requests to be transmitted to the presentation layer.

In one aspect, a calendar system receives calendar inputs from the user and stores the calendar input in the data repository.

In another aspect, the data repository stores data related to each of the following: enterprise projects, enterprise issues, enterprise documents, enterprise policies, enterprise calendars, enterprise teams, enterprise assets, enterprise vendors, and enterprise estimates.

In another aspect, the user interface displays data related to each of the following: project planning, project status, issue management, time and expenses, documents, policy management, and productivity tools.

In one aspect, the system is utilized for enterprise data, for data governance, and data risk and compliance governance.

### BRIEF DESCRIPTION OF THE DRAWINGS

A complete understanding of the present invention and the advantages and features thereof will be more readily understood by reference to the following detailed description when considered in conjunction with the accompanying drawings wherein:

FIG. 1 illustrates a schematic of the enterprise data monitoring and management system, according to some embodiments;

FIG. 2 illustrates a schematic of the team and data management systems, according to some embodiments;

FIG. 3 illustrates a screenshot of the user interface including a graphical data environment, according to some embodiments;

FIG. 4 illustrates a screenshot of the user dashboard provided via the user interface, according to some embodiments;

FIG. 5 illustrates a screenshot of the user dashboard provided on the user interface, according to some embodiments;

FIG. 6 illustrates a screenshot of the time management interface provided via the user interface, according to some embodiments;

FIG. 7 illustrates a screenshot of the project status interface provided via the user interface, according to some embodiments; and

FIG. 8 illustrates the project and data set management interface, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Before describing in detail exemplary embodiments, it is noted that the embodiments reside primarily in combinations of components and procedures related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

As used herein, the term “enterprise” can include corporations, governments, non-profit groups, groups, and other enterprise organizations.

As used herein, the term “users” can include members of the enterprise. Users may refer to employees, contractors, executives, directors, owners, partners, consultants, and likewise members of the enterprise. The term “user” may also be extended to vendors, customers, or other affiliated personnel. Some embodiments may include users who are non-human, such as online avatars, neural networks, industrial robots, artificial intelligence components, and other devices for monitoring events and personnel.

The embodiments disclosed herein relate to a system and method for managing and monitoring enterprise data. The system provides enterprises with a comprehensive, integrated data tool to facilitate data monitoring by members of the enterprise. Members may interact with a graphical user interface to view projects, policies, events, issues, documents, calendars and schedules, personnel and teams thereof, time and expenses, vendors, estimates, etc. including any data used or created by the enterprise. Members may utilize the system to manage projects, report and visualize events, resolve or manage issues, monitor resources, interact with document repositories, manage policies, and engage with productivity tools. The system also facilitates data governance and risk compliance.

Data is visualized graphically and hierarchically to provide an intuitive graphical user interface which organizes data by various metrics. The user may customize metrics to efficiently view data for specific projects and/or individuals of the enterprise.

The system permits strategic planning, project management, team communication, operational standardization, task delegation, task status, scheduling, and asset management through the various exemplary interfaces provided herein. The system as a whole can serve as an online interface between an organization and the people responsible for its development, operations, activities, management, and oversight.

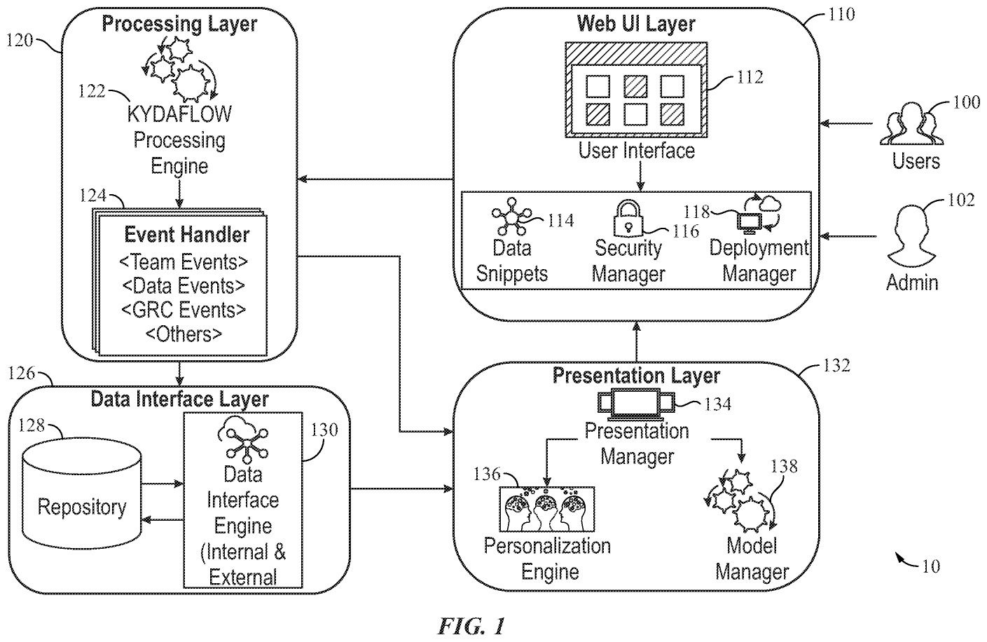

FIG. 1 illustrates the system 10 environment including users 100 and administrators 102 in communication with a web user interface (UI) layer 110. The web UI layer 110 is comprised of a user interface 112 which displays information to the user 100 and/or administrator 102. The user interface 112 may display data snippets interface 114, a security manager interface 116, and a deployment manager interface 118. The web UI layer 110 is in operable communication with a processing layer 120 comprised of a processing engine 122 and an event handler 124. A data interface layer 126 received input signals from the processing layer 120. The data interface layer 126 is comprised of a repository 128 (e.g., database) and a data interface engine 130 which includes internal and external data. A presentation layer 132 receives input signals from the processing layer 120 and the data interface layer 126 and transmit an output signal to the web UI layer 110. The presentation layer 132 is comprised of a presentation manager 134, a personalization engine 136, and a model manager 138.

Users 100 can access the system 10 to interact with the functionalities described herein. The web UI layer 110 provides access to the functionalities of the system 10 to enable self-service data search and discovery. The administrators 102 may access an administrator interface to set up security and assign access privileges to users 100 and groups thereof. The web UI layer 110 submits an output signal (request) to the processing layer 120 and displays data received from the presentation layer 132.

The user interface 112 is accessible via a web browser and installed location URL. The user interface 112 provides login options based on the tenant configuration of the user 100. User 100 login credentials are stored in repository 128.

The data snippets interface 114 creates customized data maps via user 100 input such that data can be viewed in a format of the users 100 choosing. The formatting may include date format, language preferences, component options, and customer data standards.

The security manager interface 116 permits the user 100 or administrator 102 to handle permissions for users, roles, and groups.

The deployment manager interface 118 manages application deployments and components required to access each application deployment. An administrator 102 may utilize the deployment manager interface 118 to deploy and update the system 10.

Processing layer 120 provides a means for processing user 100 and administrator 102 requests upon the request of a service. A service request can include the creation of data, the extraction of data, and the modification of data. Before the processing layer 120 processes a request, the web UI layer 110 validates the request to ensure that the request is authorized by the permission of the security manager interface 116. The processing layer 120 parses the request and transmits the request to the event handler 124 to complete the request. Results of the request, generated by the event handler 124, are transmitted to the web UI layer 110 via the presentation layer 132.

The processing engine 122 parses the request to determine where the request is routed within the system 10. Each deployment of a request can have one or more licensed applications, and each application is comprised of a plurality of modules each having a plurality of processes. The processing engine 122 identifies the nature of the request and assembles the required information to complete the processing by the event handler 124. If the request is invalid or incomplete, the processing engine 122 transmits the request to the presentation layer 132 for further processing. The processing engine 122 may engage with various requests including requests that are handled by the event handler 124, requests that are for the display of data which are transmitted to the presentation layer 132, and requests which are simple notification requests which are transmitted to the presentation layer 132.

The event handler 124 maintains a catalog of event types and dependencies. The event handler 124 receives a processing request from the processing engine 122 and determines a means for executing the request. If the event handler 124 determines multiple dependency events execution is required for the request, the event handler 124 then executes the request. If parallel processing of the request is required to complete the request, the event handler 124 collects and aggregates information required to complete the request. If data access is needed to complete the request, the event handler 124 sends and receives data through the data interface layer 126.

The data interface layer 126 processes requests for data received from the web UI layer 110. The interface engine 130 interacts with the data repository 128 to send and receive data per the request. Any internal or external requests are transmitted through the interface engine 130 which utilizes appropriate interface calls to the data repository to extract the data of the request.

The data repository 128 stores and maintains all data objects including security, configurations, applications data and relationships therebetween. External data interfaces may also be hosted by the data repository 128. Data stored within the repository can include product data (licenses, applications, modules, customization details), security data (users, groups, roles and permissions, audits etc.), application data (business applications data), external data (link or actual data and interface definitions), and workflow data (workflow approvals, reviews, submissions, events etc.).

The data interface engine 130 transmits the required data requested by the event handler 124. Request types can include database types, external access, data view, and data updates and retrieval. If a request for database types is received, the data interface engine 130 uses appropriate data libraries or connection to access the requested data. If a request for external access is received, the data interface engine 130 determines an access method (cloud, third-party). If a request for data view is received, the data interface engine 130 builds a logical view of one or more datasets. If a request for data updates or retrieval is received, the data interface engine 130 determines the optimal means to retrieve/cache the data.

The presentation layer 132 receives and transmits all user interface 112 requests and handles the method of presenting the data to each user 100 depending on the user's preferences.

The personalization engine 136 permits each user 100 to establish user preferences including types of data the user wants to interact within their dashboard displayed via the user interface 112, access to the data they are authorized to engage with, and data processing limitations. The personalization engine 136 gathers and aggregates all preferences and transmits the preferences to the presentation manager 134.

The model manager 138 provides a standard format for packaging reusable storage format models. The goal of the model manager 138 is to represent how the model should be invoked such that different types of downstream deployment tools can utilize the model manager 138. To accomplish this, the model manager 138 can store a model and data files while transmitting each to a big data platform for training and evaluation of the model.

The presentation manager 134 receives requests from the processing layer 120 and combines the results from the data interface layer 126, personalization engine 136 and model manager 138 to for presentation to the user via the user interface 112. In one example, the presentation manager 134 handles requests from the personalization engine 136 to display data in a user-desired format on the user interface 112.

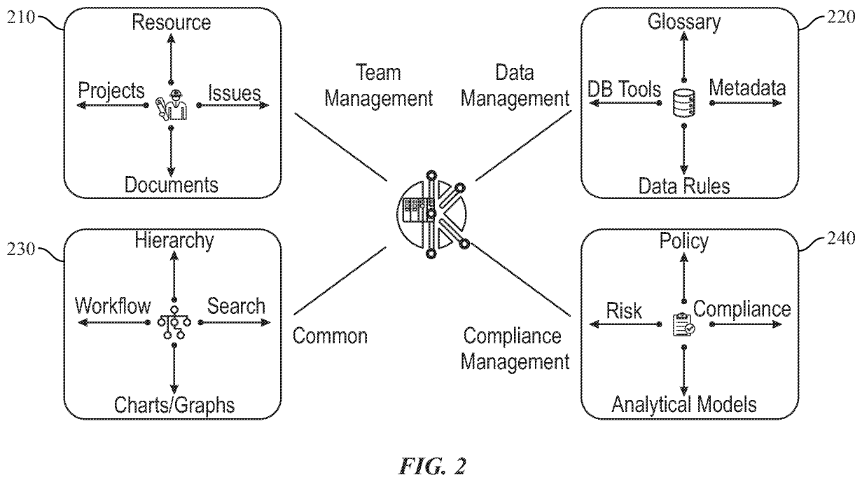

FIG. 2 illustrates the team management system 210, data management system 220, common system 230, and compliance management system 240 provided by the system. The team management system 210 provides interfaces for resources, projects, issues, and documents related to all facets of the enterprise. The data management system 220 provides an interface including database tools, metadata, data rules, and a glossary. The common system 230 provides a data hierarchy, workflow, search, and charts/graphs to the user interface. The compliance management system 240 provides policy information, risk assessment, compliance, and analytical methods to the user interface.

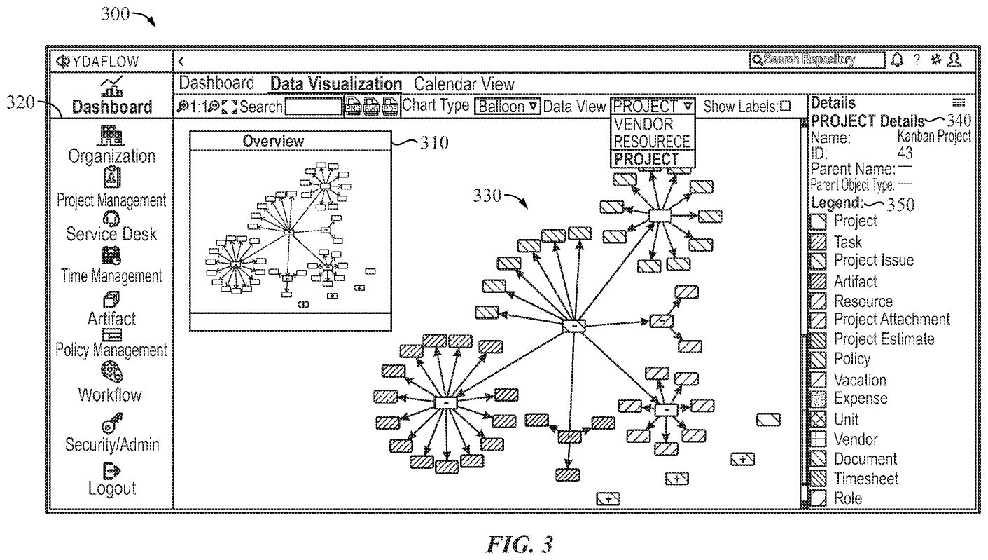

FIG. 3 illustrates the dashboard 300 displayed on the user interface. An overview window 310 displays a graphical data representation which is detailed in the main interface 330. The dashboard interface 300 provides various selectable dashboard categories 320 including the organization (enterprise), project management, service desk, time management, artifact, policy management, workflow, security/admin, and logout functions. A details interface provides project details 340 and a legend 350 for each data item present on the data visualization interface 330. The legend gives a visual categorization of data which includes projects, tasks, project issues, artifacts, resources, project attachments, project estimates, policies, vacations, expenses, units, vendors, documents, timesheets, roles, and other categories provided by the system or created by the user. The system allows for the user to customize their legend 350 and categories thereof.

The data visualization interface 330 allows for the user to selectively organize data in a configuration that is intuitive. Each user may create a personal scheme for the data visualization interface 330, a personal legend, or other metrics.

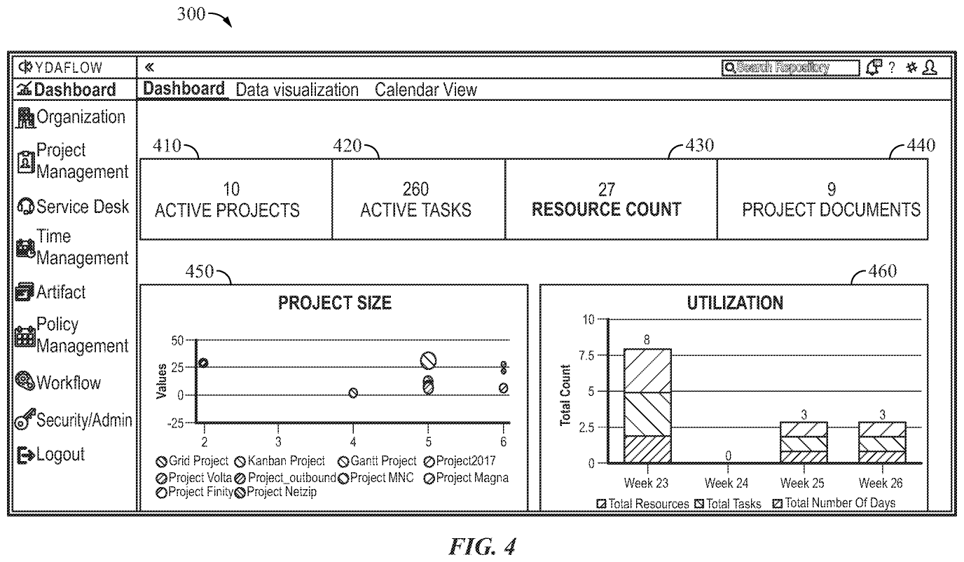

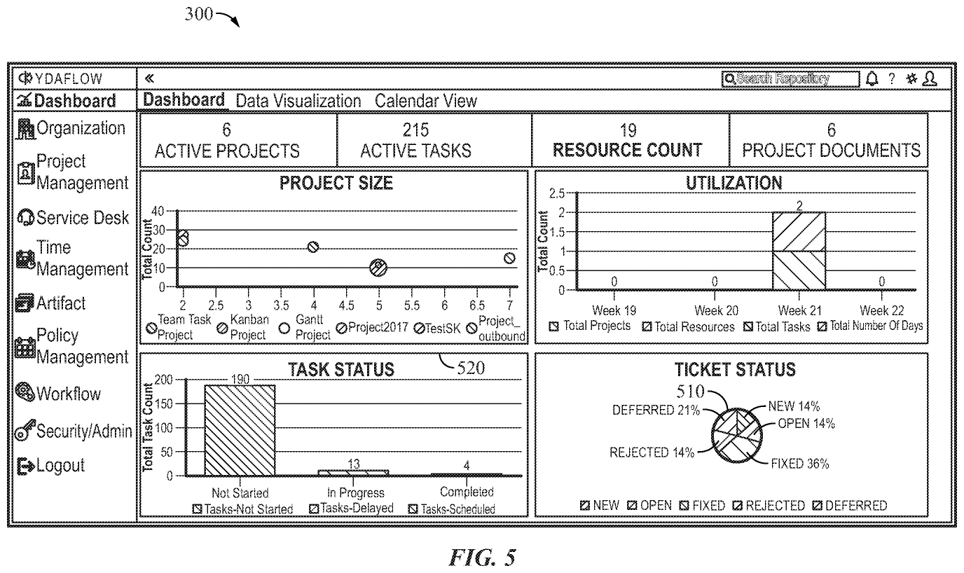

FIG. 4 and FIG. 5 illustrate the dashboard 300 interfaces. The dashboard 300 may include selectable categories showing visualizations of data requests including active projects 410, active tasks 420, resource count 430, and project document 440, among other categories such as ticket status 510 and task status 520. It is to be understood that a variety of categories can be created by the user depending on user preferences or data type. In the illustrated embodiment, the resource count 430 category is selected to illustrate the project size 450 and utilization 460 metrics.

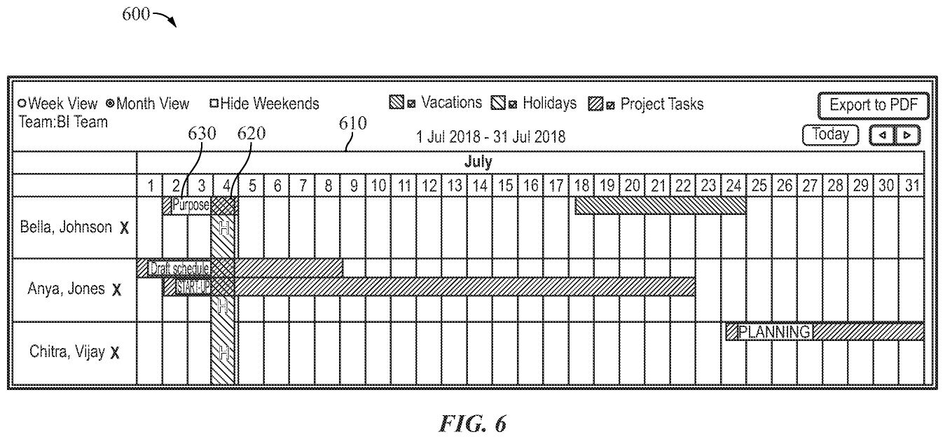

FIG. 6 shows a calendar system 600 which displays a calendar interface 610 having events 620 and event labels 630 which are created by users of the system. The calendar interface 610 may display individual or group schedules for various time periods. The calendar system 600 includes functionalities to customize event legends, time periods, users, or other metrics.

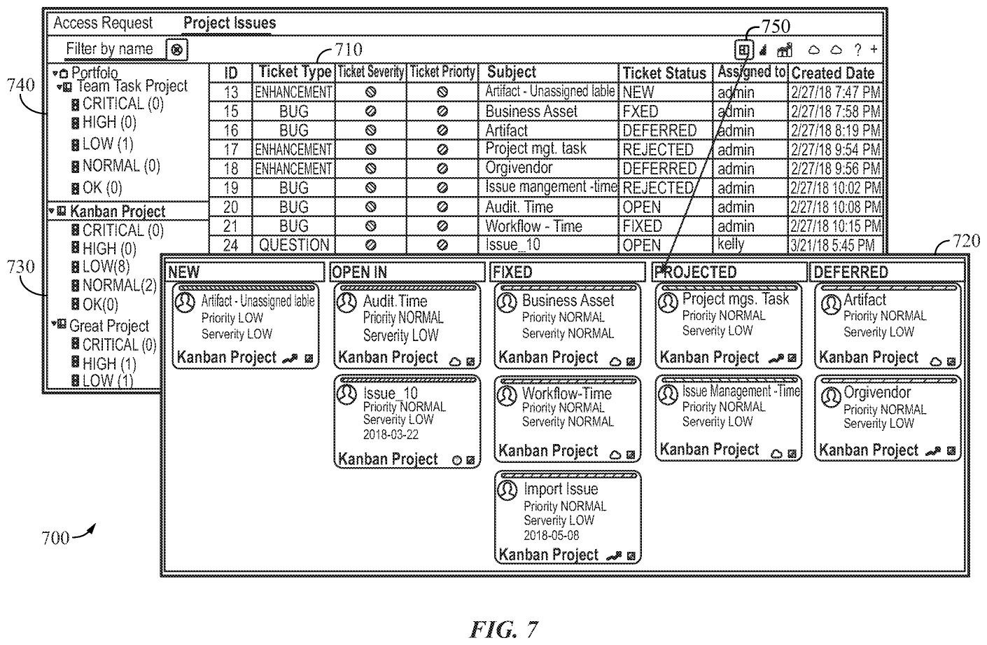

FIG. 7 illustrates the project issues interface 700 which organizes projects by ticket type 710, severity, priority, subject, status, assignment, and creation date. Project portfolio windows 730 and 740 allow the user to organize the project issues which they view. Window 720 shows individual project issues including the indicated priority level and severity. The window 720 may organize projects by status indicators which include new, open, fixed, projected, and deferred indicators. The user may select to view project issues in the window 720 by selecting, dragging, and dropping the view tab 750 (as illustrated by the arrow extending between the view tab 750 and the window 720) to customize the layout of the project issues interface 700.

FIG. 8 illustrates an integrated view of the project and dataset management interface 800 providing various selectable tabs for functionalities described hereinabove. The project and dataset management interface 800 connects enterprise users and teams thereof with datasets and business components to improve productivity by providing an intuitive data landscape on the graphic user interface. Further, the users can manage policy and compliance processes across the enterprise. The project and dataset management interface 800 allows for the integration of data assets including data extracts, rules, mappings, and technical, business, and operational business metadata along with data science models.

In some embodiments, the project and dataset management interface 800 includes a dashboard having selectable tabs including organization, business asset, data browser, data registry, data mapping, metadata manager, project management, service requests, time management, artifact, policy management, compliance manager, model repository, risk register, workflow, diagram editor, security and administrator, and logout tabs.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system customizing, monitoring, and managing events and personnel in an enterprise, the system comprising:
a web user interface layer configured to receive one or more requests from a user and transmits the request to a processing layer, the processing layer configured to transmit a processing request via a parsed request and transmit the processing request to an event handler to determine if the processing request requires access to data stored in a data repository in communication with a data interface layer, the data interface layer configured to issue an interface call to the data repository to access the data and execute the processing request; and
a personalization engine contained in a presentation layer, the personalization engine permits the user to select a presentation scheme from a plurality of metrics, the presentation layer receives the executed processing request from the data interface layer, the presentation layer configured to determine a presentation scheme corresponding to the user via a presentation manager configured to combine executed processing requests received from the data interface layer with the presentation scheme and display the executed processing request data on a user interface on a computing device.

2. The system of claim 1, wherein the web user interface layer receives the request from the user and transmits an output signal to the presentation layer.

3. The system of claim 1, further comprising a security manager interface controlled by an administrator, the security manager interface displayed on the user interface to permit the administrator to select data permissions for the user.

4. The system of claim 3, wherein the web user interface layer validates the request via the security manager before the request is transmitted to the processing layer.

5. The system of claim 1, further comprising a data snippets interface permitting the user to create customized data schemes displayed on the user interface.

6. The system of claim 1, wherein the processing engine determines a request type, wherein the request type includes:
requests to be executed by the event handler;
requests to display data to be transmitted to the presentation layer; and
simple requests to be transmitted to the presentation layer.

7. The system of claim 1, further comprising a calendar system receive calendar inputs from the user and store the calendar input in the data repository.

8. The system of claim 1, wherein the data repository stores data related to each of the following: enterprise projects, enterprise issues, enterprise documents, enterprise policies, enterprise calendars, enterprise teams, enterprise assets, enterprise vendors, and enterprise estimates.

9. The system of claim 1, wherein the user interface displays data related to each of the following: project planning, project status, issue management, time and expenses, documents, policy management, and productivity tools.

10. The system of claim 1, wherein the system is utilized for enterprise data, for data governance, and data risk and compliance governance.

11. A system customizing, monitoring, and managing events and personnel in an enterprise, the system comprising:
a web user interface layer configured to receive one or more requests from a user and transmit the request to a processing layer, the processing layer configured to transmit a processing request via a parsed request and transmit the processing request to an event handler configured to perform the following:
determining the access requirements of the processing request;
issuing an interface call to a data repository in communication with a data interface layer including an interface engine to permit access to the data if the access requirements are satisfied;
accessing data stored in the data repository;
executing the processing request; and
transmitting the executed processing request to a presentation layer; and
a personalization engine contained in the presentation layer, the personalization engine permits the user to select a presentation scheme from a plurality of metrics, the presentation layer receives the executed processing request from the data interface layer, the presentation layer configured to determine a presentation scheme corresponding to the user via a presentation manager configured to combine executed processing requests received from the data interface layer with the presentation scheme and display the executed processing request data on a user interface on a computing device.

12. The system of claim 11, wherein the data repository is comprised of product data, security data, application data, external data, and workflow data.

13. The system of claim 11, further comprising a model manager performing the step of determining a model to display for the user and stores the user-associated model in the data repository.

14. The system of claim 13, wherein the user interface displays data categories related to each of the following: project planning, project status, issue management, time and expenses, documents, policy management, and productivity tools.

15. The system of claim 14, further comprising a legend system created by the user, wherein the legend system permits the user to customize the display of data categories on the user interface.

16. The system of claim 11, further comprising a security manager interface controlled by an administrator, the security manager interface displayed on the user interface to permit the administrator to select data permissions for the user.

17. The system of claim 16, wherein the web user interface layer validates the request via the security manager before the request is transmitted to the processing layer.

18. The system of claim 11, wherein the data interface engine is operable to determine a logical data view comprised of a plurality of data sets and aggregate the data for display on the user interface.

19. The system of claim 11, wherein the data request is internal or external of the enterprise.

20. A method for customizing, monitoring, and managing events and personnel in an enterprise, the method comprising the steps of:
receiving, via a web user interface layer, one or more requests from a user and transmitting the request to a processing layer;
transmitting, via the processing layer, a processing request via a parsed request and to an event handler configured to perform the following:
determining the access requirements of the processing request;
issuing an interface call to a data repository in communication with a data interface layer including an interface engine to permit access to the data if the access requirements are satisfied;
accessing data stored in the data repository;
executing the processing request; and
transmitting the executed processing request to a presentation layer; and
permitting, via a personalization engine included in the presentation layer, the user to select a presentation scheme from a plurality of metrics;
receiving, via the presentation layer, the executed processing request from the data interface layer, and determining a presentation scheme corresponding to the user via a presentation manager;
combining, via the presentation manager, executed processing requests received from the data interface layer with the presentation scheme; and
displaying, via a user interface, the executed processing request data on a computing device.
